(19) United States
(12) Patent Application Publication
(10) Pub. No.: US 2012/0235482 A1
(43) Pub. Date: Sep. 20, 2012

(54) POWER SYSTEM UTILIZING BATTERY CYCLING AND RECHARGING

(76) Inventor: Fernando Alves Pereira, N. Palm Beach, FL (US)

(21) Appl. No.: 13/369,672

(22) Filed: Feb. 9, 2012

Related U.S. Application Data
(60) Provisional application No. 61/441,074, filed on Feb. 9, 2011.

(51) Int. Cl. H02J 1/00

(52) U.S. Cl. 307/29

(57) ABSTRACT

A power system includes a plurality of batteries, or other power sources or storage element, selectively connectable to an inverter to provide an AC voltage to a distribution panel. The system includes recharging circuitry to allow the batteries, or other power sources to be constantly recharged prior to full discharge.

### CROSS REFERENCE TO RELATED APPLICATIONS

The present application claims benefit of and priority to U.S. Provisional Patent Application Ser. No. 61/441,074 filed Feb. 9, 2011 and entitled POWER SYSTEM UTILIZING BATTERY CYCLING AND RECHARGING, the entire content of which is hereby incorporated by reference herein.

### BACKGROUND

1. Field of the Disclosure

The present disclosure relates to a power system utilizing battery cycling and recharging to extend the life of the power system.

2. Related Art

Battery driven power systems that supply or back-up power for an AC distribution panel have been available for some time. These systems, however, tend to have a relatively short operational life, since the batteries are quickly exhausted during use.

Accordingly, it would be beneficial to provide a power system that avoids these and other problems.

### SUMMARY

It is an object of the present invention to provide a power system including a battery array that utilizes battery cycling and recharging to extend battery life.

The power system of the present application utilizes battery cycling to provide a 5 KW power source to demand without the use of carbon fuel for an extended period of operation without recharge.

The system also includes added facilities of renewable charge, which will further enhance the operational life of the system. The technology and system will have similar applicability to lower and higher power requirements. That is, the system may similarly be used to provide more or less power, as desired.

A power system in accordance with an embodiment of the present application includes a power source configured to provide power at a predetermined voltage, a distribution element connected to the power source and operable to provide power to at least one load at a desired voltage, a plurality of power storage elements, connected to the distribution element and configured and operable to provide power at a second predetermined voltage, a plurality of switches, each switch positioned between a respective power storage element and the distribution element and configured to selectively connect each of the power storage elements to the distribution element and a controller operable to control the plurality of switches to selectively connect one or more of the plurality of power storage elements to the distribution element when the predetermined voltage provided by the power source changes to maintain the desired voltage to be provided to the load and to maintain substantially the predetermined voltage in each of the power storage elements.

A power system in accordance with another embodiment of the present application includes a plurality of power storage elements configured and operable to provide power at a predetermined voltage, a plurality of switches, each switch connected to a respective power storage element and configured to selectively connect each of the power storage elements to a load, a charge element connected to each power storage element of the plurality of storage elements and configured and operable to selective recharge each power storage when a voltage of the power storage element drops below a minimum desired voltage and a controller operable to control the plurality of switches and the charge element to selectively connect one or more of the plurality of power storage elements to the load to maintain the desired voltage to be provided to the load and to maintain substantially the predetermined voltage in each of the power storage elements.

Other features and advantages of the present invention will become apparent from the following description of the invention, which refers to the accompanying drawings.

### BRIEF DESCRIPTION OF THE DRAWINGS

FIG. 1 is a diagram illustrating an exemplary embodiment of a power system in accordance with an embodiment of the present application.

### DETAILED DESCRIPTION OF THE EMBODIMENTS

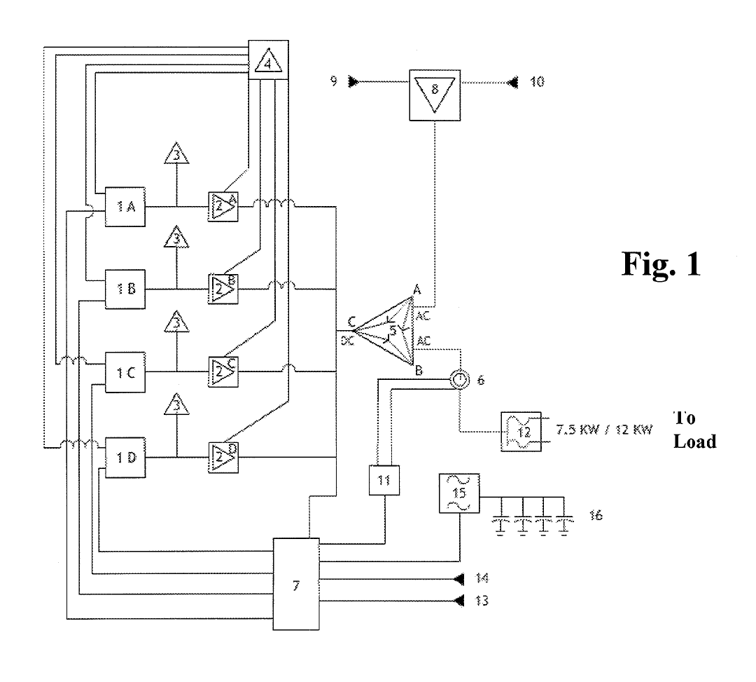

FIG. 1 illustrates a power system 100 in accordance with an exemplary embodiment of the present application. Generally, the system 100 includes a plurality of batteries, or other power sources or storage elements, such as capacitors, for example, 1A, 1B, 1C, 1D that are connected in parallel to an inverter/charger device 5. A plurality of corresponding switches 2A, 2B, 2C, and 2D are connected between each of the batteries and the inverter/charge 5 such that each battery is selectively connected thereto. A controller 4 is provided to control the switches and selectively connect one or more batteries to the inverter/charger 5.

The inverter/charger 5 is connected to a distribution box 12 to which a load is connected. The inverter/charger 5 preferably provides 120V AC at 60 Hz or 120/240 V AC at 60 Hz to the distribution box 12 to provide 5-12 kW of power, depending on requirements. This voltage may be provided from the grid via terminal 9 or via an AC generator 10, which are selectively connected to the panel 12 via the transfer switch 8 and through the inverter/charger 5. In the event of a grid or generator failure, however, the batteries 1A-1D will provide the desired AC power to the panel 12 via the inverter/charger 5.

In one embodiment, the batteries 1A-1D are 12 V batteries. It is noted, however, that the batteries may be of any desired voltage including but not limited to 24V, 36V or 48V. When the system is ON, the controller 4 controls the switch 2A to connect the battery 1A to the inverter/charger 5. During operation, the 12V battery 1A will draw down toward 11 V. The battery level indicator 3 provided for each battery preferably visually indicates the charge status of each battery. Information related to the charge status of each battery is also conveyed to the controller 4. When the controller 4 receives a low voltage signal to indicate the lowered charge level for the battery 1A. The controller 4 will close one of the switches 2B, 2C or 2D to connect one of the other batteries 1B, 1C or 1D to the inverted/charge 5. This second battery will be connected in parallel with the battery 1A such that the two batteries work together. The battery controller 4 will then receive a signal indicating the raised voltage to 12V or better resulting from the two batteries working together. In response, battery controller 4 will open the switch 2A while switch 2B remains closed allowing the corresponding battery 1B to remain connected to the inverter/charger 5. The battery 1A is preferably subsequently connected to the charge circuitry to be recharged as described below. The system 100 is now in automatic mode such that this process repeats itself through all the batteries and passes until the complete system has been depleted of capable charge above 11V. That is, the system 100 cycles through batteries in an attempt to limit depletion of any one battery. This not only extends the life of the batteries, it also allows for each battery to quickly recharge to at least near capacity.

While the above discusses the use of a plurality of batteries 1A, 1B, 1C, 1D, any suitable power source or storage element may be used in place of the individual batteries. For example, each battery may be replaced by one or more capacitors. In another embodiment, each of the batteries 1A, 1B, 1C, 1D may be embodied by multiple batteries connected together. Similarly, each of the batteries 1A, 1B, 1C, and 1D may be embodied by a combination of batteries and capacitors, if desired.

The operation described above has been simplified somewhat. Acceptance and on/off use as well as charging may or may not be sequential, or limited to two batteries. For example, the battery 1B may be in single use and drop near the 11V reading. The battery controller 4 will then select a capable power source to switch to. If battery 1A has the highest charge state, i.e. 12V, then this battery will be selected to add to the battery 1B before the switch 2b is signaled to open and release battery 1B to be recharged by the charge circuitry. Similarly, in the event that battery 1A nears the 11V reading and both batteries 1C and 1D read 11.85V, the controller 4 may signal both electronic switches 2C and 2D to close allowing battery 1C and 1D to connect in parallel with battery 1B.

Upon acceptance, a new high reading of 12V or more will trigger the controller 4 to signal switch 2b to open. The battery 1B may then be recharged by the charge circuitry with battery 1A such that two batteries support the electricity needs and the other two are recharged.

The system 100 also allows for the charging of the batteries 1A-1D via a variety of charging options. First, as noted above, the system 100 is preferably connected to the electrical grid at terminal 9. Both the grid terminal 9 and the generator 10 are preferably connected to transfer switch 8 which may be used to selectively connect the inverter/charger 5 to the grid or the generator.

When the distribution panel is not drawing current, the batteries 1A-1D will accept a direct voltage and power via wire C via the inverter/charger 5 either direct from the grid 9 or generator 10. In this instance, the inverter/charger 5 acts as a charger converting AC from the grid or generator to DC to charge the batteries. Simultaneously, other current passing through the inverter/charger 5 will be directed to the charge controller 7 via wire C.

A current transformer 6 is provided between the inverter/charger 5 and the distribution panel 12. When the distribution panel 12 draws AC current, the majority of the current is provided to the panel, while a small amount is sent as pulse voltage to the charger controller 7 via the Current On Demand Automatic Voltage Regulator 11. The current transformer 6 may be a device similar to that used in current sensors. The current transformer 6 excites the power 100% of the time when power is drawn from the distribution panel 12.

Whether current is or is not being drawn by the distribution panel 12, the batteries 1A-D will also accept charge and power from three other charging options via the charger controller 7. The charger controller 7 acts as an equalizer and stabilizer to transfer voltage to charge the batteries 1A-1D. The specific battery 1A, 1B, 1C or 1D showing the lowest voltage will be the sole beneficiary of voltage from the charger controller 7 until this battery reaches capacity or reaches a voltage level equal to another battery with voltage below capacity. At this point, the charger controller 7 will share the charge proportionally to each. Similarly, if no battery in the sequence is at full capacity, at some point, the charge through the charger controller 7 will distribute the charge proportionately to all the batteries.

As noted above, in the event that the incoming power fails from the transfer switch 8, the system will go ON automatically, supplying requested 120/240 volts 60 HZ to the distribution panel 12. The system 100 is also usable without a connection to a grid power source or an interrupted power supply. In this case, the charger controller 7 accepts charge and power from single or multiple energy sources. A Solar Panel/Film 13 may be connected to the charger controller 7 for extra charging. In addition, or alternatively, a wind generator or turbine 14 may be used to provide charging power. Further, a static generator 15 operable to provide charging power based on static electricity inherent in the environment may be connected to the charger controller 7. The static generator 15 will preferably include at least one and preferably several Double Layer/Ultracapacitors 16, which allow for storage of static energy for use in charging the batteries.

The inverter/charger 5 includes both charging circuitry and inverter circuitry. When power/voltage is present at terminal A of the inverter/charger 5, and no current is being drawn by the panel 12, only the charger works converting 120 Volts AC to 12 Volts DC to charge all of 12V DC batteries, under control of the charger controller 7, through the terminal C. The inverter function is not in use and does not perform any function at this time.

When power/voltage is present at terminal A of inverter/charger 5 it is also connected to terminal B sending direct AC power to the distribution panel 12.

When no power/voltage is present at terminal A, only the inverter function of the inverter/charger 5 works converting the 12 volts from the terminal C batteries into the terminal B, 120 volts AC for the distribution panel 12.

One of the advantages provided by the system 100 of the present application is that the controller 4 controls battery usage to maximize battery life. Since the controller 4 switches between batteries 1A, 1B, 1C and 1D before any one battery gets drawn down too much, all of the batteries can be kept in a state close to full charge. This allows for fast recharge times and extends the useful life of the batteries as well. Thus, the system 100 provides for a long life and reliable power source.

Although the present invention has been described in relation to particular embodiments thereof, many other variations and modifications and other uses will become apparent to those skilled in the art.

What is claimed is:

1. A power system comprising:
a power source configured to provide power at a predetermined voltage;
a distribution element connected to the power source and operable to provide power to at least one load at a desired voltage;
a plurality of power storage elements, connected to the distribution element and configured and operable to provide power at a second predetermined voltage;
a plurality of switches, each switch positioned between a respective power storage element and the distribution element and configured to selectively connect each of the power storage elements to the distribution element; and
a controller operable to control the plurality of switches to selectively connect one or more of the plurality of power storage elements to the distribution element when the predetermined voltage provided by the power source changes to maintain the desired voltage to be provided to the load and to maintain substantially the predetermined voltage in each of the power storage elements.

2. A power system comprising:
a plurality of power storage elements configured and operable to provide power at a predetermined voltage;
a plurality of switches, each switch connected to a respective power storage element and configured to selectively connect each of the power storage elements to a load;
a charge element connected to each power storage element of the plurality of storage elements and configured and operable to selective recharge each power storage when a voltage of the power storage element drops below a minimum desired voltage; and
a controller operable to control the plurality of switches and the charge element to selectively connect one or more of the plurality of power storage elements to the load to maintain the desired voltage to be provided to the load and to maintain substantially the predetermined voltage in each of the power storage elements.
